(19) United States
(12) Patent Application Publication
(10) Pub. No.: US 2026/0205479 A1
(43) Pub. Date: Jul. 16, 2026

(54) OPEN FINANCE ABUSE DETECTION

(71) Applicant: Wells Fargo Bank, N.A., San Francisco, CA (US)

(72) Inventors: Vamsi Kadiyala, Media, PA (US); Serkan Gunpinar, Irving, TX (US); Kristine Wetch, Goodyear, AZ (US); Finley D. Hammond, Lewis Center, OH (US); Saibala Lakkaraju, Mckinney, TX (US)

(21) Appl. No.: 19/021,891

(22) Filed: Jan. 15, 2025

(51) Int. Cl. H04L 9/40; H04L 41/16

(52) U.S. Cl. CPC H04L 63/1425; H04L 41/16

(57) ABSTRACT

This disclosure describes techniques for determining anomalies in interaction data and determining a risk score based on the identification of an anomaly. A computing system is configured to obtain interaction data that includes data regarding interactions by organizations with an institution, wherein the interactions include requests for data maintain by the institution for each of a plurality of customers of the institution, and wherein the interactions by the organizations occur through an aggregator institution. The computing system is further configured to apply a learned module to the interaction date to identify an anomaly associated with the interactions. The computing system is further configured to determine, based on the identification of the anomaly, a risk score associated with the specific customer. The computing system is further configured to take an action, based on the risk score satisfying a threshold risk score, to respond to the risk score.

### TECHNICAL FIELD

This disclosure relates to computer networks, and more specifically, to evaluating network activity in a distributed environment.

### BACKGROUND

Open finance or open banking is the sharing, by a financial institution, of customer financial information with parties other than originating financial institutions. The originating financial institutions may, upon customer request, securely share financial information of the customer with other third parties, such as aggregators, and those aggregators may then further share the financial information with other parties. In some jurisdictions, financial institutions may be required by law to permit access by third parties to customer financial information when requested by the customer.

### SUMMARY

This disclosure describes techniques for determining anomalous usage of customer financial information by aggregators and other third parties using learned models (e.g., machine learning (ML) or other models). A financial information aggregator (e.g., a third party) may obtain customer financial information on behalf of a number of other parties and other entities which may in turn share the information with other parties. However, the originating financial institution (e.g., the first party, alternatively referred to as “financial institution” or “institution”) may lack visibility into the usage of the financial data and whether any of the other parties are misusing the financial data. For example, the financial information aggregator may be unwilling or unable to share information with the financial institution about how other parties use financial information obtained by the aggregator. Furthermore, the aggregator itself might not capture what information the other parties are requesting, how often the other parties request financial information, and other statistics on how the other parties are using the financial information obtained using the aggregator.

An analysis system implementing the techniques described herein may use various learned models to identify anomalies with requests for information by the aggregator. In some examples, the analysis system may use ML models that are trained to identify different types of anomalies within obtained interaction data that include: number of connected financial applications, enrollment activity (e.g., how many and/or how often applications are connected to a customer identifier), data requests (e.g., anomalies in the requests for data), and/or other types of anomalies. The analysis system may determine a risk score associated with a customer identifier based on the identified anomalies and may provide an alert to one or more recipients based on the risk score.

The techniques described herein may provide one or more technical advantages. For instance, the application of learned models to interaction data may enable the analysis system to identify anomalies when the aggregator does not provide information regarding other parties involved in a financial information request process. In another example, the use of an automated anomaly system may enable a financial institution to identify potential misuse of customer information associated with requests for information even when the number of requests greatly exceeds what human members of the financial institution are capable of reviewing in a timely manner. In addition, the use of multiple ML models that are each trained to identify particular types of anomalies may enable the financial institution to identify anomalous activity that may have otherwise gone unnoticed. In some examples, the aggregation of the output of the ML models may enable the financial institution to identify anomalous use of the financial information that may not be apparent from individual anomalies or from risk detection systems otherwise in place at the financial institution.

In an example, a method includes obtaining, by a computing system of an institution, interaction data that includes data regarding interactions by organizations with the institution, wherein the interactions include requests for data maintained by the institution for each of a plurality of customers of the institution, and wherein the interactions by the organizations occur through an aggregator institution; applying, by the computing system, a trained model to the interaction data to identify an anomaly associated with the interactions, wherein the anomaly is associated with a specific customer of the plurality of customers of the institution; determining, by the computing system and based on the identification of the anomaly, a risk score associated with the customer; and taking an action, by the computing system and based on the risk score satisfying a threshold risk score, to respond to the risk score.

In another example, a computing system includes memory; and processing circuitry in communication with the memory and configured to: obtain interaction data that includes data regarding interactions by organizations with an institution, wherein the interactions include requests for data maintain by the institution for each of a plurality of customers of the institution, and wherein the interactions by the organizations occur through an aggregator institution; apply a trained module to the interaction date to identify an anomaly associated with the interactions, wherein the anomaly is associated with a specific customer of the plurality of customers of the institution; determine, based on the identification of the anomaly, a risk score associated with the specific customer; and take an action, based on the risk score satisfying a threshold risk score, to respond to the risk score.

In yet another example, non-transitory computer-readable media includes instructions that, when executed, cause processing circuitry to: obtain interaction data that includes data regarding interactions by organizations with an institution, wherein the interactions include requests for data maintain by the institution for each of a plurality of customers of the institution, and wherein the interactions by the organizations occur through an aggregator institution; apply a trained module to the interaction date to identify an anomaly associated with the interactions, wherein the anomaly is associated with a specific customer of the plurality of customers of the institution; determine, based on the identification of the anomaly, a risk score associated with the specific customer; and take an action, based on the risk score satisfying a threshold risk score, to respond to the risk score.

### BRIEF DESCRIPTION OF THE DRAWINGS

FIG. 1 is a conceptual diagram illustrating an example system for analyzing information financial information requests, in accordance with one or more aspects of the present disclosure.

FIG. 2 is a block diagram illustrating an example analysis system that analyzes financial information requests, in accordance with one or more aspects of the present disclosure.

FIG. 3 is a conceptual diagram illustrating a configuration and operation of an analysis system for identifying anomalies, in accordance with one or more aspects of the present disclosure.

FIG. 4 is a flow diagram illustrating an example operation for training a learned model, in accordance with one or more aspects of the present disclosure.

FIG. 5 is a flow diagram illustrating an example operation performed by an anomaly system, in accordance with one or more aspects of the present disclosure.

### DETAILED DESCRIPTION

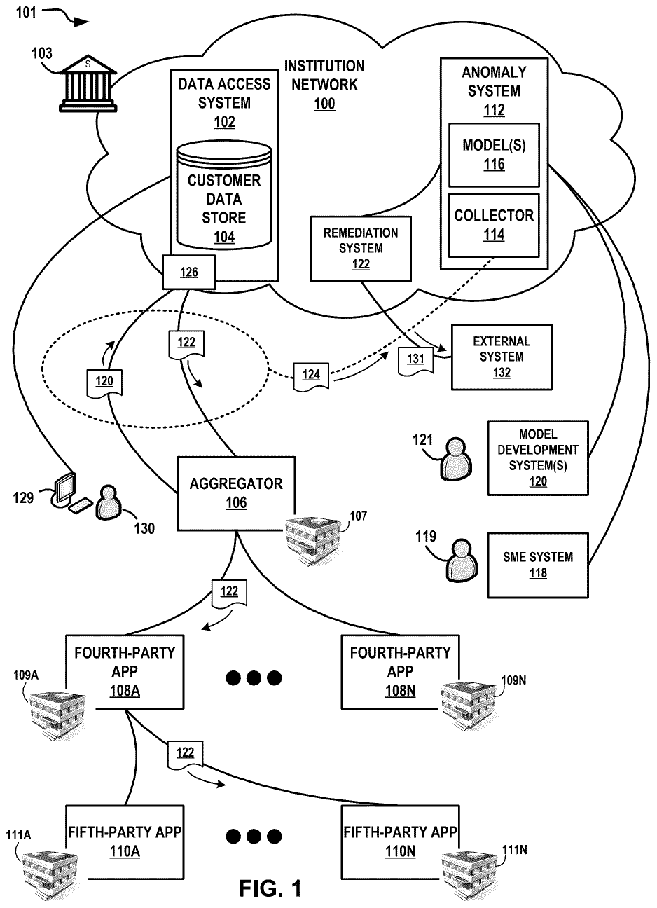

FIG. 1 is a conceptual diagram illustrating an example system 101 for analyzing information financial information requests, in accordance with one or more aspects of the present disclosure. In the example of FIG. 1, system 101 includes institution network 100 associated with institution 103, aggregator 106. fourth-party apps 180A-108N (hereinafter “fourth-party apps 108”), fifth-party apps 110A-110N (hereinafter “fifth-party apps 110”), subject matter expert (“SME”) system 118, model development systems 120, customer device 129, and external system 132.

Institution network 100 may be used or operated by institution 103, a financial institution (“institution”, “originating institution”, “first-party”) that receives and responds to open banking or open finance requests from other parties. Accordingly, institution 103 may be a bank, credit union, wealth management firm, asset management firm, or any other financial institution that may receive and/or respond to such requests. Institution network 100 may include one or more networks, such as cloud networks (e.g., public cloud, private cloud), distributed networks, remote networks, on-premises networks, and/or other types of networks. Institution network 100 may be a network that logically connects one or more services, such as SaaS services, together within a network or collection of networks. In addition, institution network 100 may represent one or more networks of institution 103.

As shown in FIG. 1, institution network 100 includes data access system 102, which may be a computing system owned, operated, or otherwise controlled by institution 103 that manages requests for data that is maintained by institution 103. Data access system 102 may be implemented through any suitable computing system or collection of computing systems, and may include one or more types of computing systems, such as servers, mainframes, cloud computing systems, virtualized computing systems, and/or other types of computing systems. Data access system 102 may maintain one or more databases, data repositories, and/or other types of data storage, such as customer data store 104.

Data access system 102 includes customer data 104, which may include customer information. Customer data store 104 may include one or more types of data storage, such as databases, data repositories, cloud storage, and/or other types of data storage. Customer data store 104 may include financial information associated with the customers of institution 103, such as transaction records, account balances, identifying information, information regarding product usage (e.g., does the customer use a wealth management service, have a mortgage and/or credit card with institution 103, etc.). Data access system 102 may associate financial information with individual customer identifiers. For example, data access system 102 may associate a given transaction with an alphanumeric identifier of the customer who conducted the transaction.

Data access system 102 may manage access to customer information (“customer financial information”) stored in customer data store 104 by entities and/or organizations external to institution 103 (e.g., aggregator organization 107, fourth-party organizations 109A-109N, fifth-party organizations 111A-111N, etc.). Institution 103 implements data access system 102 to comply with open banking and/or open finance regulations that may require institution 103 to make customer data available to other organizations when the customer approves or requests such access for those other organizations. One or more of the other organizations may use customer data from data access system 102 to offer a variety of financial products or services for the customer (e.g., budgeting applications, wealth management, mortgages, auto loans, etc.). For example, fourth-party organization 109A may provide fourth-party app 108A that enables customer 130 to use their banking information to create real-time budgets and saving plans. Data access system 102 may determine whether an entity requesting customer data is allowed to access customer data store 104 and/or which portions of customer data store 104 the request is not allowed to access for a given customer. Data access system 102 may determine that a given requesting organization is authorized to access financial information associated with a particular customer identifier and grant access to the financial information associated with the customer identifier in response to a request.

Data access system 102 may receive approval, from customer device 129, to provide financial information to recipients outside of institution network 100. Customer device 129 may be operated by a customer of the financial institution receiving open banking requests. Customer device 129 may be implemented through any appropriate computing system, such as one or more types of computing devices such as laptops, desktops, tablet computers, smartphones, wearable computing devices (e.g., smartwatches, AR/VR goggles/glasses, and/or other types of wearable devices), virtualized computing devices, and/or other types of computing device. Customer device 129 may enable a customer 130 of institution 103 to request that data access system 102 provide access to financial data associated with customer 130 for organizations that are external to data access system 102 (e.g., aggregator organization 107, fourth-party organizations 109N, etc.). In an example, customer device 129 generates, based on input from customer 130, an indication that includes a request for institution 103 to provide aggregator organization 107 that is external to institution network 100 with access to financial information associated with customer 131 that is stored by institution 103. Customer device 129 provides the indication to data access system 102 (e.g., by outputting the indication over a network to data access system 102). Data access system 102 processes the indication and grants access to the customer data to aggregator 106 provided by aggregator organization 107. In some examples, data access system 102 uses an identifier associated with customer 131 to determine whether and to what extent to grant access.

Data access system 102 may receive indications from customer device 129 requesting institution 103 grant access to customer data store 104 for an open banking or open finance aggregator, such as aggregator 106 provided by aggregator organization 107. Aggregator organization 107 may provide aggregator 106 to enable customers to more easily leverage open finance by enabling the customer to provide aggregator 106 with authorization to access their data and allow aggregator 106 to share the data with other applications, rather than individually granting authorization for each individual application to obtain financial information from data access system 102. Aggregator 106 may include one or more computing systems of an entity that provides a data transfer network for financial information and/or other types of information. For example, aggregator 106 may be a financial data aggregator that accesses data maintained by institution 103 for customers of institution 103 and as pursuant to open banking regulations that facilitate access to the data. Aggregator 106 may facilitate the exchange of data between institution network 100 and other organizations, such as fourth-party organizations 109A-109N (hereinafter “fourth-party organizations 109”) and fifth-party organizations 111A-111N (hereinafter “fifth-party organizations 111”). For example, aggregator 106 may accesses the data maintained by institution 103 for each of the plurality of customers from institution 103 pursuant to open banking regulations that facilitate access to the data.

In order regulate or mediate access to customer data store 104, data access system 102 may generate and provide tokens to aggregator 106. The tokens, when provided with a request, are used to authenticate the validity of the request. The tokens thereby enable aggregator 106 to request information from data access system 102. Data access system 102 may receive an indication from customer device 129 to grant access for aggregator 106 and generate the token based on the indication. Data access system 102 may generate tokens that include an identifier of aggregator 106, an identifier of customer 130, and an indication of the data that the token grants access to. Data access system 102 may provide the token to aggregator 106 for aggregator 106 to use by the aggregator 106 when that aggregator seeks to obtain data for connected applications (e.g., the apps provided by fourth-party organizations 109 and/or fifth-party organizations 111).

Aggregator 106 may receive indications of access approval from customer device 129 granting approval for other entities to access financial information of customer 130. Customer device 129 may generate, based on input from a customer 130, the indications of access approval that indicate one or more entities and/or connected applications associated with the entities that may access the financial information of customer 130. Customer device 129 may provide the indications of access approval to data access system 102. In an example, customer device 129 receives user input consistent with a selection of a fourth-party financial services application, such as fourth-party app 108A. Customer device 129 generates an indication of customer 130 granting access fourth-party app 108A access to the financial data of customer 130 and provides the indication to data access system 102. Data access system 102 receives the indication from customer device 129 and processes the indication. Based on the indication from customer device 129, data access system 102 grants access to financial data associated with customer 130 within customer data store 104 for fourth-party app 108A.

Fourth-party apps 108A-108N (hereinafter “fourth party apps 108”) may include one or more applications (alternatively referred to as “connected applications” or “connected apps” throughout) that use financial information to provide one or more products or services and are themselves provided by fourth-party organizations 109. Fourth party-apps 108 may be provided by financial services organizations, such as fourth-party organizations 109, that leverage the customer data to support the products and services. For example, fourth party apps 108 may include a budgeting application that uses financial information to assist customer 130 in budgeting for various expenses and an application that assists customer 130 in obtaining home insurance. Fourth-party apps 108 may obtain and consume information from institution 103 in order to provide the one or more products or services. Fourth-party apps 108 may generate and provide requests for information to aggregator 106, which may in turn generate requests for information from data access system 102.

Aggregator 106 may generate enrollment requests that include requests to enroll one or more of fourth-party apps 108 for access to customer data store 104. Customer device 129 may generate a request to enroll one or more of fourth-party apps 108 and provide the request to aggregator 106. Aggregator 106 may process the request and generate an enrollment request for the fourth party application. Aggregator 106 may provide the enrollment request to data access system 102 via API 126.

Aggregator 106 may provide an enrollment request to data access system 102 via application programming interface (API) 126. API 126 may include one or more software components of institution network 100 that facilitate the exchange of data between institution network 100 and entities exterior to institution network 100. Data access system 102 may expose API 126 to enable aggregator 106 and/or other entities to access customer data store 104. Data access system 102 may expose API 126 as adhering to standardized protocols for secured data exchange. For example, data access system 102 may expose API 126 to enable the use of open banking.

In some examples, data access system 102 may process enrollment requests received from aggregator 106. In such examples, data access system 102, as part of processing such enrollment requests, determines whether customer 130 has granted, for each such enrollment request, access to financial information associated with customer 130 (i.e., data stored in customer data store 104). If data access system 102 determines that customer 130 has granted access, data access system 102 may enroll the fourth-party app associated with the request. In some examples, data access system 102 may determine whether one or more of fourth-party apps should be enrolled based on other factors.

Fourth-party apps 108 may request information from aggregator 106. Fourth-party apps 108 may generate requests for information that include indications of what information is requested by fourth-party apps 108 and provide the requests to aggregator 106. In an example, fourth-party app 108A determines that particular financial information about customer 130 is needed to determine the eligibility of customer 130 for a particular financial product, such as a loan or credit card. Fourth-party app 108A generates a request for information and provides it to aggregator 106 for aggregator 106 to obtain from data access system 102.

Aggregator 106 may generate requests 120 for information and provide requests 120 to data access system 102 via API 126. Aggregator 106 may receive requests for information from fourth-party apps 108 and generate requests 120 based on the requests from fourth-party apps 108 and as including an indication of type of information sought. For example, aggregator 106 may generate an instance of requests 120 that includes an indication specifying a type of financial information sought by one of fourth-party apps 108 and provide the instance of requests 120 to data access system 102.

Data access system 102 may process requests 120 and determine whether to provide the requested information to aggregator 106. Data access system 102 may determine whether to provide requested information based on one or more factors that include: determining whether the requesting fourth-party application is allowed to access data from customer data store 104, whether customer 130 has granted access to the type of data requested, and/or other factors. In an example, data access system 102 receives a request 120 for information about a mortgage held by customer 130 and identifying fourth-party app 108N as the requesting application. Data access system 102 processes the instance and determines it is authorized to provide the information regarding the mortgage to fourth-party app 108N. Data access system 102 retrieves data about the mortgage from customer data 102 and sends the data to aggregator 106 as information 122.

Data access system 102 may send information 122 to aggregator 106 for aggregator 106 to distribute to fourth-party apps 108. For example, data access system 102 packages information from customer data store 104 (e.g., compile the information into a secure message) and provides the information via API 126 to aggregator 106. Data access system 102 thereby securely transmits information 122 to aggregator 106 to ensure the security and confidentiality of the financial information.

Aggregator 106 may distribute information 122 received from data access system 102 to fourth-party apps 108. For instance, in one example, aggregator 106 receives information 122 from data access system 102 and determine which of fourth-party apps 108 to provide information 122 to. In an example, aggregator 106 receives information 122 as including mortgage information from data access system 102. Aggregator 106 determines that fourth-party app 108A is the intended recipient of information 122 and securely provides information 122 to fourth-party app 108A. In some examples, aggregator 106 provides a portion of information 122 to a first fourth-party app and a different portion of information 122 to a second fourth-party app.

Fourth-party apps 108 may process information 122 received from aggregator 106. For instance, fourth-party apps 108 process information 122 as part of providing services and/or products to customer 130. As part of processing information 122, fourth-party apps 108 may provide some or all of information 122 to other recipients, such as fifth-party apps 110A-110N.

Fifth-party apps 110A-110N (hereinafter “fifth-party apps 110”) may include one or more applications provided by fifth-party organizations 111. Fifth-party organizations 111 may be customers of fourth-party organizations 109. For instance, fifth-party organizations 111 include financial service organizations that obtain information from information resellers of fourth-party organizations 109 in some examples. Fifth-party apps 110 include applications that are not in direct communication with aggregator 106 and instead obtain information 122 from fourth-party apps 108. In an example, fifth-party app 110A is a financial services application that is in communication with fourth-party app 108A and that uses customer information purchased from fourth-party app 108A. Fifth-party 110A obtains information 122 from fourth-party 108A without requesting information 122 from aggregator 106.

The institution (institution 103) that controls data access system 102 (e.g., a financial institution that provides banking services to customers 130) may find it challenging to ensure that customer data is not misused by external entities, such as fourth-party apps 108 and/or fifth-party apps 108. For example, institution 103 may not have visibility into how fourth-party apps 108 use customer information as aggregator 106 may not share information such information. Furthermore, members of institution 103 tasked with identifying anomalous and potentially fraudulent activity associated with use of an aggregator in a timely manner due to the sheer number of requests for information generated by the aggregator (e.g., an institution may receive on the order of tens of millions of requests per day) that preclude such a timely analysis to address potential fraud. Furthermore, institution 103 may be unable to determine which entities have access to the customer information as fourth-party apps 108 may not indicate which applications fourth-party apps 108, such that even aggregator 106 is not privy to which fifth-party entities are using customer information. For example, institution 103 may be unable to ascertain whether a fifth-party app is improperly using customer information resold or otherwise provided by a fourth-party organization. In addition, institution 103 may need to identify malicious activity by threat actors that use attacks distributed across multiple services simultaneously to evade detection by traditional systems.

While open banking/open finance may provide benefits for customer 130, institution 103 may identify one or more risks associated with open banking/open finance. Institution 130 may identify risks that include:
Account Takeover Fraud: Individuals may exploit vulnerabilities in third-party applications or weak authentication processes to gain unauthorized access to customer accounts. These individuals may use the data of the compromised account on a third party portal, or jumping off from the data of third party portal to socially engineer or glean credential information for the customer's account at institution 103.
Data Breaches: As more entities gain access to sensitive financial data, institution 103 may determine that the risk of breaches increases. A breach at a third-party provider (TPP) may compromise customer data from multiple banks, particularly if retention/handling of the data by the connected app is not completely understood.
Malicious Apps and Services: Bad actors may create seemingly legitimate applications designed to manage stolen/fraudulent accounts more easily and programmatically. Additionally, authorized bank connections may add more legitimacy to otherwise illegitimate schemes (abusive loan programs) encouraging users to give more personal information they would normally.
API Vulnerabilities: Individuals may exploit flaws in API design or implementation to gain unauthorized access to data or systems.
Identity Spoofing: Fraudsters may impersonate legitimate users or TPPs to gain access to sensitive information or leverage their access to further compromise the customer

Institution 130 may experience challenges in detecting the above threats. For instance, institution 130 experiences challenges that include:
High Volume of Data: Open banking generates a large number of API calls and data requests, making it difficult to detect anomalies in real-time.
Complex Ecosystem: The open banking environment involves multiple parties (banks, TPPs, customers), complicating the ability to monitor all interactions and threats.
Similarity to Legitimate Activity: Fraudulent activities may closely resemble legitimate user behavior, making detection more difficult.
Lack of Historical Patterns: Open banking is relatively new, so institution may have access to limited historical data on fraud patterns, complicating the creation of effective detection systems.
Evolving Attack Techniques: Fraudsters continually adapt their methods, often outpacing traditional detection mechanisms.
6. Limited Visibility: Financial institutions may have limited insight into the security practices of TPPs, making it difficult to assess and mitigate risks effectively.

In accordance with the techniques of this disclosure, institution network includes anomaly system 112 which identifies anomalies in app enrollments and requests for information. Anomaly system 112 may capture interaction data regarding interactions between aggregator 106 and data access system 102. In at least some examples, anomaly system 112 uses a learned model to identify anomalies in the interaction data and determines a risk score based on the identified anomalies.

Anomaly system 112 may include one or more types of computing systems that obtain and process interaction data. For example, anomaly system 112 may include one or more of servers, mainframes, virtual machines, and/or other types of computing system or computing environments. Anomaly system 112 may include one or more components that provide functionality of anomaly system, such as collector 114.

Collector 114 may be a software component of anomaly system that obtains interactions data for consumption by anomaly system 112. Collector 114 may obtain interaction data 124 in one or more ways, such as capturing data received and sent via API 126, causing data access system 102 to report information, capturing communications between data access system 102 and aggregator 106, and/or other ways. For example, collector 114 may interact with API 126 and obtain interaction information by monitoring or capturing requests 120 and information 122 exchanged between data access system 102 and aggregator 106.

Anomaly system 112 includes one or more models 116, which may be software components of anomaly system 112. Models 116 may include one or more types of models, such as learned models, machine learning (ML) models, recurrent neural network (RNNs), deep-learning models, Q-learning models, and/or other types of learned models. Models 116 may include learned models that are trained using one or more types of training data. For example, modules 116 may include a learned model trained on historical information requests received from a financial data aggregator. Models 116 may include learned models trained to identify different types of anomalies. For example, models 116 may include a first learned model trained to identify anomalous login activity, a second model trained to identify anomalous app enrollments, and a third model trained to identify data requests and token data from interaction data 124.

Anomaly system 112 may apply one or more of models 116 to identify anomalies within interaction data 124. Anomaly system 112 may apply models 116 to identify one or more types of anomalies, such as anomalous token use, anomalous enrollments of apps, anomalous requests for data, anomalous use of tokens, and/or other anomalies. Models 116 may receive interaction data as input and identify outliers in the data that correspond to anomalies in interaction data 124. Models 116 provide the outliers as output to anomaly system 112. In some examples, models 116 may identify anomalies in an unsupervised manner, and may do so without requiring labels for the anomalies.

Anomaly system 112 may apply models 116 to sets of interaction data 124 corresponding to time-based windows of interactions between aggregator 106 and/or other type of time-based sets of interaction data 124. In one example, anomaly system 112 applies models 116 to an instance of interaction data 124 that represent an observed day's activities and compare the activities with N-days of historical activities of the same customer. Anomaly system 112 may organize such data to represent interactions in terms of similarity and fraction (e.g., total and average volume of requests by customer, type of information requested by customer etc., as compared to their historic average and maximum). Anomaly system 112 may apply models 116 to observed activity patterns in day-to-day activities of a given customer, such as the volume of requests, payload length/bytes out, type of data requests, session failure rates, processing/response duration, and/or other patterns of activity. Further, anomaly system 112 may apply models 116 to compare daily activities of a customer with other similarly situated customers (e.g., customers of the same institution). For example, anomaly system 112 may represent observed daily activities for each customer compared with the same day activities of rest of the customers. In another example, anomaly system 112 may apply models 116 to compare a given set of interactions to interactions within a historical window, analyze interactions for a predetermined periodic based on types of interactions, and compare, over a period of time, interactions associated with the specific customer with interactions associated with other customers of the plurality of customers. Anomaly system 112 may use the historic time windows to identify anomalies within predetermined periods of time.

Model development systems 120 may train and/or develop learned models that include models 116. Model development systems 120 may include one or more types of computing systems, such as server, desktops, virtual machines, and/or other types of computing systems that facilitate the training and/or development of models 116 by model developer 121. Specifically, model development systems 120 may train models 116 to identify anomalies associated with connected applications, aggregator enrollment, data requests, and/or activities associated with open banking processes. In an example, model developer 121 may select an initial algorithm and cause model development system to train the algorithm using training data, which may include labeled instances previously identified anomalies or unlabeled instances of similar data. Model development systems 120 may tune hyper-parameters of the selected algorithm, based on input from a model developer 121, as part of developing the model.

In some examples, model development system 120 obtains feedback from SME system 118 regarding the development of models 116. SME system 118 may include one or more types of computing systems, such as server, desktops, laptops, virtual machines and/or other types of computing systems. SME system 118 may enable subject matter expert 119 (hereinafter “SME 119”) to provide feedback on the development one or more models by model development systems 120. In an example, model development system 120 trains a first instance of a learned model and provides information about the first learned model to SME system 118. SME system 118 receives the information and presents it to SME 119 through a user interface. Model development system 120 detects input that it interprets as feedback from SME 119 about the first learned model. Based on the feedback, model development systems 120 train a second learned model, which may be considered an updated version of the first learned model.

Models 116 may output indications of anomalies that are indicative of anomalous behaviors. Each model of models 116 may output indications of different types of anomalies that correspond to different types of anomalous behavior. For example, a first model 116 may output indications that correspond to unvetted and unsecured connected applications, a second model 116 may output indications that correspond to use of expired tokens, and a third model 116 may output indications that correspond to improper data access by connected applications.

Anomaly system 112 may process the anomalies identified by models 116 to determine a risk score. Anomaly system 112 may determine a risk score that is associated with a customer of institution 103 (e.g., associated with an identifier of customer 130) and that is indicative of a risk associated with connected applications receiving financial information of the customer (e.g., fourth-party apps 108, fifth-party apps 110). For example, anomaly system 112 may determine a numerical risk score for customer 130 based on anomalous requests and expired tokens received from aggregator 106.

In some examples, anomaly system 112 determines the risk score by aggregating the identified anomalous into a risk profile for a customer. Anomaly system 112 may aggregate different types of anomalies determined by models 116 into a risk profile that corresponds to the various types of risks associated with open finance (e.g., misuse of customer data, improper access by applications, etc.). For instance, anomaly system 112 may aggregate the anomalies identified by models 116 into a risk profile associated with customer 130, where the risk profile corresponds to the types of risks particular to the use of open finance by customer 130.

Anomaly system 112 may generate and provide an indication of one or more risk score thresholds being satisfied to one or more recipient and/or external computing systems. Anomaly system 112 may generate an indication that includes an identifier of the one or more satisfied risk score thresholds, an identifier of the associated customer, and/or other information. For example, anomaly system may provide an indication to remediation system 122 based on determining that at least one risk score threshold has been satisfied for a customer.

Remediation system 122 may include one or more computing systems that may execute remedial actions. Remediation system 122 may include one or more types of computing systems such as servers, desktops, virtual machines, and/or other types of computing system. Remediation system 122 may determine whether to take an action based on the risk score and/or risk profile associated with a customer. Remediation system 122 may determine whether a risk score exceeds one or more threshold risk scores. For example, remediation system 122 may compare a risk score and/or risk profile to one or more risk score thresholds to determine whether to take an action and, if so, which action to take. Remediation system 122 may determine what type of action(s) to take based on the magnitude of the risk score and which of the risk score thresholds the risk score satisfies. For example, remediation system 122 may determine that a comparatively drastic action should be taken based on a comparatively high-risk score threshold being satisfied.

Remediation system 122 may take one or more actions. Remediation system 122 may take actions that include generating an alert, generating instructions for an external system, and/or other actions in response to determining that at least one risk score threshold has been satisfied. In an example, remediation system 122 determines that a risk score threshold has been satisfied by a risk score associated with customer 130. Remediation system 122 determines that an alert should be generated based on the risk score threshold being satisfied. Remediation system 122 generates the alert and provides the alert to recipient computing systems.

In some examples, remediation system 122 may generate instructions 131 for one or more recipient devices or external systems in response to determining that a risk score threshold has been satisfied. Remediation system 122 may generate instructions 131 as configured to cause another computing system, such as external system 132, to execute one or more actions that include modifying access to customer data store 104 by aggregator 106, generating and providing an alert to aggregator 106, disabling access associated with particular tokens, and/or other actions. External system 132 may execute one or more actions in response to receiving instructions 131 from remediation system 122.

In some examples, remediation system 122 may send control signals to control one or more external systems 132. Specifically, remediation system 122 may, based on information received from anomaly system 112 (e.g., information about predictions made by models 116), send control signals to an external system 132, instructing the external system to perform a specific operation. In one example, remediation system 122 outputs a series of signals to an external system 132, and that external system 132 receives the signals and determines that the signals include instructions for taking an action in response to a risk score. External system 132 performs an action, which may involve modifying the operation of a network device, increasing (or decreasing) the security processes performed by a security control, modifying network traffic or traffic patterns, changing access rights, permissions, authorizations, privileges, or other access controls, or otherwise modifying the operation of any system illustrated in FIG. 1. Accordingly, anomaly system 112, through remediation system 122, controls the operation of one or more external systems 132.

The techniques of this disclosure may provide one or more practical advantages. For example, the use of anomaly system 112 to obtain and process interaction information using models 116 may enable automated detection of anomalous activity even though institution 103 does not have access to aggregator 106. Further, the use of the automated anomaly system may enable institution 103 to identify anomalous and potentially fraudulent use of aggregator 106 in a timely manner when even when institution 103 receives amounts of requests for information that would overwhelm human reviewers. In another example, the use of multiple learned models that are each respectively trained to identify different types of anomalies may facilitate identification of anomalous and potentially fraudulent usage of customer financial information by various applications, even when fourth-party applications share information with fifth-party applications. Furthermore, the automated generation of instructions to cause recipient systems to execute an action may enable automated remediation of improper usage of customer financial information.

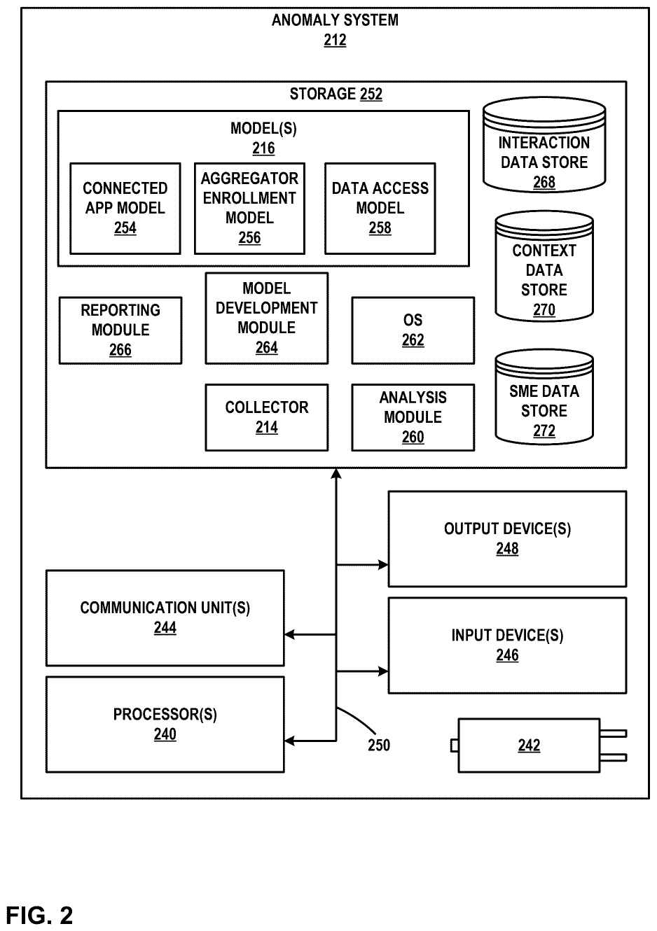

FIG. 2 is a block diagram illustrating an example anomaly system 212 that analyzes financial information requests, in accordance with one or more aspects of the present disclosure. Anomaly system 212 may be similar to analysis system 112 as illustrated in FIG. 1 and may provide similar functionality.

In FIG. 2, anomaly system 212 includes one or more processors 240, which mobile processors, desktop processors, server processors, compute nodes, virtualized processors, processing circuitry, and/or other types of processors. Processors 240 may execute the instructions of one or more processes of anomaly system 212 and implement functionality of the one or more processes.

Anomaly system 212 includes one or more communication units 244, which may include one or more components such as network interface cards (NICs), wireless radios such as cellular modems and WIFI radios, transceivers, and other components. Communication units 244 may enable anomaly system 212 to communicate with other computing devices and systems using any appropriate communication protocol (e.g., TCP/IP). Communication units 244 may enable anomaly system 212 to communicate with any other device illustrated in FIG. 1, such as data access system 102 and/or remediation system 122.

Anomaly system 212 includes power source 242, which may include one or more sources of power such a connection to an electrical grid, a connection to local power sources (e.g., solar, battery, power generation system, or various backup systems), and/or other sources of power. Power source 242 may provide the power that enables anomaly system 212 to operate.

Anomaly system 212 includes input devices 246 and output devices 248. Input devices 246 may include one or more devices capable of providing input to anomaly system 212 such as keyboards, mice, touchscreens, touchpads, microphones, video cameras, and other types of input devices. Output devices 246 may include one or more devices capable of generating output such as displays, speakers, haptic engines, light indicators, and other devices capable of generating output.

Communication channels 250 may include one or more components such as hardware connections, software connections, hardware interconnects, and other channels that interconnect one or more components of anomaly system 212. In general, communication channels 250 enable communication between the components of anomaly system 212. For example, communication channels 250 interconnect processors 240 and storage 252.

Anomaly system 212 includes storage 252, which may include one or more storage components such as hard disk drives, solid state drives, magnetic tape drives, disk drives, virtualized storage, and other components. Storage 252 may store instructions and data for one or more software components of anomaly system 212. For example, storage 252 may store instructions of an operating system (OS) for execution by processors 230.

Storage 252 includes operating system 262 (illustrated as “OS 262”, hereinafter referred to as the same), which may provide a software platform on which various processes executing on anomaly system 212 may operate. In general, OS 262 may provide an execution environment for one or more software components of anomaly system 212 such as collector 214.

Storage 252 includes collector 214. Collector 214 may be an example of collector 114 illustrated in FIG. 1 and may provide similar functionality. For example, collector 214 may obtain interaction data, such as interaction data 124 from communications between a data access system, such as data access system 102, and an aggregator, such as aggregator 106, as illustrated in FIG. 1. Collector 214 may capture the interaction data and store the interaction data in interaction data store 268.

Storage 252 includes interaction data store 268, which may store one or more types of data structures, such as a database, data repository, and/or other type of data structure. Collector 214 may store interaction data 124 in interaction data store 268 and organize the interaction data based on customer identifiers. In an example, collector 214 obtains interaction data, stores the interaction data in interaction data store 268, and organizes the interaction data based on associated customer identifiers.

Storage 252 includes analysis module 260, which may be a software component of anomaly system 212 that orchestrates the analysis of data. Analysis module 260 may cause one or more components of anomaly system 212 to process data and/or perform other functions as part of determining anomalies in interaction data. For example, analysis system 260 may apply one or more of models 216 to data stored in interaction data store 268.

Storage 252 includes models 216, which may be learned models that are examples of or are similar to models 116 illustrated in FIG. 1, and which may provide similar functionality. For example, models 216 may include learned models, such as ML models, which are trained to identify different types of anomalies within interaction data. In the example illustrated in FIG. 2, models 216 include connected app model 254, aggregator enrollment model 256 and data access model 258. Connected app model 254 may include one or more types of learned models trained to identify anomalous connected applications per aggregator (e.g., identifying an anomalous number of connected applications, identifying applications known to misuse customer information and/or otherwise be suspect, and/or anomalies in the connected applications). Aggregator enrollment model 256 may include one or more types of learned models that are trained to identify anomalous activity in enrollment of connected applications and/or aggregators (e.g., anomalies with enrollment of connected application with an aggregator and/or with institution 103, such as fourth-parties apps 108 with aggregator 106 or aggregator 106 enrolling with institution 103). Data access model 258 may include one or more types of learned models that are trained to identify anomalies within data requests and/or aggregator tokens.

Models 216 may identify anomalies that are indicative of unwanted behaviors by aggregator 106 and/or connected applications. Models 216 may identify anomalies that in interaction data that include one-time password bypass attempts, high credential login attempts (continued attempts to login even after a lock-out period), unchecked enrollment counts to unique apps by customer (e.g., abnormal number of app enrollment requests, apps connected to claims, etc.), repeated enrollment for the same app, cookie reuse by customers (e.g., an identical cookie being associated with different customers), failed token revocations, and/or other anomalies. In some examples, models 216 identify behaviors that are indicative of zero-day vulnerabilities or compromises of third-party organizations 109 and/or fourth-party organizations 111, attack automations, credential stuffing, and/or money laundering.

Connected app model 254 may identify anomalies that are indicative of unvetted and/or unsecured connected applications (e.g., connected applications that have not been verified as complying with data protection requirements), abuse of customer data (e.g., for offering short-term loans, for offering unwanted products to a customer, etc.), improper data access (e.g., obtaining access to customer data that the customer has not authorized the application to access), organizations as exceeding an application risk threshold, and to provide visibility into applications that are newly connected among other behaviors. Connected app model 254 utilizes an ensemble learning approach generates a risk score for each connected app, enabling proactive monitoring and potential revocation of access for high-risk apps. Connected app model 254 may determine anomalies by:
Monitoring the volume and types of data requests made by each app.
Identifying unusual spikes or changes in activity.
Identifying trends in the errors the apps generate.
Reviewing the app's historical performance and any reported issues.
Collecting fraud claims and complaints post account linkage.

Aggregator enrollment model 256 may identify anomalies that are indicative of account take-over (e.g., signals that are indicative of an account coming under the control of a malicious actor, connected applications attempting take-over of a customer's account with institution 103, and/or other behavior indicative of malicious control or attempts to control a customer's account), weak data controls (e.g., an connected application passing data to other entities, other entities maliciously gaining access to customer data obtained by a connected application, etc.), use of expired tokens (e.g., tokens provided by the aggregator, tokens provided by institution 103, etc.), an anomalous enrollment of an organization, and/or usage of customer data to provide unwanted products (e.g., predatory short-term loans) among other behaviors. Aggregator enrollment model 256 combines rule-based logic and machine learning to score each enrollment attempt, flagging high-risk cases for further review. Aggregator enrollment model 256 may detect anomalies by:
Analyzing user behavior (e.g., time taken, error rates) during enrollment.
Examining the devices and IP addresses used for enrollment.
Assessing the risk profile of the TPP requesting access.
Evaluating unusual patterns in account linkages.

Data access model 258 may identify anomalies that are indicative improper data access (e.g., connected applications accessing data in ways not explicitly approved by a customer), unvetted and/or unsecured applications accessing customer data (e.g., fourth-party applications providing data to fifth-party applications without customer approval, applications that have insufficient data controls obtaining customer data, etc.), areas where data control may be improved, surges in attacks that are insufficiently remediated or blocked by connected apps (e.g., connected apps failing to block malicious attempts to access data), anomalous access of the data by one of the organizations, and/or other behaviors. Data access model 258 may use unsupervised learning to establish normal behavior patterns and flags deviations, helping to identify irregular or unauthorized access. In some examples, a model of models 216 may identify anomalies that are indicative of behaviors similar to those identified by another model of models 216. Data access model 258 may detect anomalies by:
Tracking the frequency and volume of data requests per customer.
Analyzing the types of data being accessed.
Identifying unusual timing or sequence patterns in data requests.
Analyzing error rates and malformed requests per customer.
Comparing current activity to historical baselines for each customer and external organizations (e.g., fourth-party organizations 109).

Data access model 258 may enable institution 103 to improve data hygiene. Data access model 258 processes interaction data and provide feedback useful for data hygiene. Data access model 258 may conduct comprehensive monitoring of API requests that provides valuable insights into data usage patterns, which can be leveraged to improve data hygiene by:
Identifying Stale Data: By tracking the frequency and recency of data access, the model may highlight accounts or connections that are rarely accessed or remain connected but inactive. Anomaly system 212 may use this information to help implement app disconnection or token deletion policies, reducing storage costs and minimizing security risks from unnecessary data access.
Optimizing Data Structures: Analysis of access patterns may reveal which data elements are frequently accessed together, informing database design decisions that may lead to more efficient data structures and improved query performance.
Detecting Data Quality Issues: Unusual access patterns or high error rates for specific data fields may indicate data quality issues. Early detection may allow for prompt investigation and correction, ensuring high standards of data integrity.

Data access model 258 may enable institution 103 to align infrastructure costs with actual usage and business value by:
Capacity Planning: By tracking API request volumes and patterns, the model may
assist in predicting future capacity needs. The model may enable more precise infrastructure scaling, avoiding over-provisioning and unnecessary costs.
Usage-Based Pricing: For institutions offering open banking as a service, the model's data may support more accurate usage-based pricing models, ensuring infrastructure costs are fairly recovered from high-volume users.
Cost Attribution: The model's ability to track usage by customer segments and other parties may enables more accurate attribution of infrastructure costs to different business lines or partners.

Data access model 258 may identify issues with how third parties request access (verbose and unexplainable patterns). To improve accountability, anomaly system 212 takes one or more of the following measures:
SLA Enforcement: By tracking response times and error rates for each party (e.g., aggregator 106, the model may automatically flag violations of Service Level Agreements (SLAs), enabling prompt enforcement actions.
Query Efficiency Monitoring: Data access model 258 may identify parties that submit inefficient or overly broad queries, enabling targeted outreach and optimization.
Automated Alerts: When a party's behavior deviates significantly from normal patterns (e.g., spikes in request volume or error rates), the anomaly system 212 automatically alerts both an operations team and the party, enabling quick investigation and resolution.
Usage Reporting: Regular reports generated from the model's data may provide transparency into aggregator and other parties' usage patterns and highlight any areas of concern.
Penalty Enforcement: For parties that consistently exceed limits or submit flawed queries, data access model 258 provides evidence for enforcing penalties or, in extreme cases, revoking access.

In some examples, models 216 may include an aggregator learned model trained to process outputs of other models. Anomaly system 212 applies the aggregator model to the outputs of the other models and/or interaction data for the aggregator model to identify anomalies. The aggregator model may identify anomalies that may reflect anomalous behavior across multiple types of interactions. For example, the aggregator model may identify an anomaly based on an enrollment of a first third-party application and improper data access by second third-party application. The aggregator provides a holistic risk view, ensure early detection of threats and maintain regulatory compliance. Furthermore, the aggregator model may interface with other, preexisting models used by institution 130 for other purposes and enable a holistic approach to fraud detection by the institution. For instance, the aggregator model provides input to and receives output from the other models as part of identifying potential misuse of customer data and other issues.

In some examples, anomaly system 212 may facilitate an initial development of one or more of models 216. For example, anomaly system 212 applies algorithms to training data and compares anomaly match rations and separation distance of anomaly scores for the different algorithms. Anomaly system 212 may select an algorithm based on factors that include match ratios, separation distance, and stability of the algorithm. As part of the initial development, anomaly system 212 performs optimal hyper-parameter tuning by comparing different hyperparameter settings. For instance, anomaly system 212 may tune the algorithm to maximize the distance between outliers and inliers.

In some examples, anomaly system 212 may facilitate the training of learned models, such as one or more of models 216, using model development module 264. Model development module 264 may include one or more types of software components that train any of models 216. Model development module 264 may train models 216 using one or more techniques, such as exploratory analysis, feature engineering, isolation forest, extended isolation forest, cluster-based local outlier factor, histogram-based outlier score, deep learning, and/or other types of training. In addition, model development module 264 may use feedback from SMEs, such as SME 119, to develop models 216. Model development module 264 may store feedback from SMEs in SME data store 272.

Storage 252 includes SME data store 272, which may include one or more types of data storage, such as a data repository. Model development module 264 may store information from SMEs that includes annotation on model training, suggested changes to models, indications of whether an SME approves or denies the model for deployment, changes in priority for types of anomalies identified, and/or feedback. In an example, model development module 264 provides information regarding the performance of a model to SME system 118 as illustrated in FIG. 1. SME system 118 generates feedback on model performance and provides the feedback to anomaly system 212. Model development module 264 receives the feedback and stores the feedback in SME data store 272. Model development module 264 modifies models 216 based on the feedback information stored in SME data store 272. For example, model development module 264 may use data in SME data store 272 to determine a contamination factor for training data used to develop the model.

In some examples, analysis module 260 aggregates the output of models 216 into an aggregated risk profile that is a comprehensive view of potential misuse of customer financial information. In such an example, analysis module 260 may aggregate the output of models to maintain a depth of analysis by each model (e.g., the particular types of anomalies that the models are trained to identify) while determining an overarching view of anomalous interactions with institution 103 systems (e.g., identifying anomalous activity or behavior that may only be apparent across multiple types of anomalies). For example, analysis module 260 may aggregate anomalies identified by each of models 216 into an aggregated risk profile that includes identifiers of the types of anomalies associated with a customer, the number of anomalies within a given time period, connected applications associated with the anomalies and other information. Analysis module 260 may generate aggregated risk profiles for one or more customers of institution 103 that have been determined as using open finance. In an example, analysis module 260 obtains information regarding anomalies associated with a particular customer identifier from models 216. Analysis module 260 aggregates the anomalies into an aggregated risk profile associated with the customer identifier, where the aggregated risk profile is a comprehensive view of potential risks associated with the use of open finance by the customer represented by the particular customer identifier. Analysis module 260 integrates model 216 into an overall risk assessment framework, providing a comprehensive view of open banking risks. Analysis module 260 may use an approach that allows for:
Real-time risk scoring of consumer enrollments and data access requests.
Identification of potentially compromised accounts or fraudulent apps.
Trend analysis to detect emerging threats.
Actionable insights for security teams to investigate and respond to threats.

In some examples, analysis module 260 may determine, based on an anomaly, a root cause of the anomaly. Analysis module 260 may process the identification of the anomaly and identify a root cause that corresponds to one or more types of behaviors, some of which may be fraudulent, malicious, or otherwise unwanted by institution 103. For example, analysis module 260 may determine that the root cause of an anomaly is the misuse of an expired token by an organization.

Analysis module 260 may determine or generate a context that includes contextual information regarding the identification of anomalies. For instance, analysis module 260 may determine a context and stores the context in context data store 270. Context data store 270 may include one or more data repositories and/or data stores that include contexts associated with customers of institution 103. Analysis module 260 may obtain information associated with anomalies identified by models 216 from interaction data store 268. For example, analysis module 260 may obtain information from interaction data store 268 used by a model to identify a particular anomaly and determine a context based on the obtained information. Analysis module 260 may include the context in the aggregated risk profile for a customer. For example, analysis module 260 may update an aggregated risk profile for a customer with a context regarding the identification of anomalies.

Analysis module 260 may determine a risk score associated with a customer identifier that is representative of a risk of misuse of customer information and/or other issues associated with connected applications. Analysis module 260 may determine the risk score based on identified anomalies, an aggregated risk profile, a context, and/or other information. Analysis module 260 may determine the risk score as a numerical score, a vector, and/or other types of representation of risks. For example, analysis module 260 may generate a risk score as a numerical score representative of a risk of misuse of customer information.

Analysis module 260 may determine whether the risk score satisfies one or more risk score thresholds. Analysis module 260 may compare the risk score to one or more risk score thresholds that are representative of different thresholds of risk, such as risk of data misuse, risk of token or credential comprise, risk of account takeover, and/or other risks and that are determined by institution 103 and/or determined by anomaly system 212. In an example, analysis module 260 compares a risk score associated with a customer identifier to a risk score threshold and determines that the risk score threshold is satisfied.

Analysis module 260 may generate and provide indications of identified anomalies and/or aggregated risk profiles to reporting module 266 based on the satisfying of a risk score threshold. Reporting module 266 may be a software component of anomaly system 212 that is configured to report the determination that a risk score satisfies at least one risk score threshold to recipient systems, such as remediation system 122 as illustrated in FIG. 1. Reporting module 266 may include an identifier of an anomaly, an aggregated risk profile, and/or other information in a report or alert as part of reporting to a recipient system. In an example, reporting module 266 receives an indication of an aggregated risk profile and that a risk score threshold being satisfied from analysis module 260. Reporting module 266 generates an indication and provides the indication to remediation system 122 for remediation system 122 to determine an action to take. In some examples, reporting module 266 may provide the functionality of remediation system 122 (e.g., determining whether to take an action, determining which action to take, generating instructions for other computing systems, generating an alert, etc.).

In some examples, analysis module 260 may triage events that are based on determinations of risk score thresholds being satisfied. As part of triaging, analysis module 260 may cause reporting module 266 to classify and prioritize alerts based on one or more factors that include severity, urgency, and potential impact of misuse of the customer data. Reporting module 266 may use the classifications from analysis module 260 to determine whether to take an action and, if so, what action to take. For example, reporting module 266 may determine that instructions should be generated to promptly remediate misuse of customer data based on a relatively high priority of alert determined by analysis module 260.

In some examples, reporting module 266 may conduct semi-autonomous decision making regarding responses to misuse of customer information. Reporting module 266 may conduct decision making to queue false positive and duplicate alerts to semi-autonomous playbook actions for resolution. For example, reporting module 266 may aggregate duplicate alerts when generating an alert to a member of institution 103.

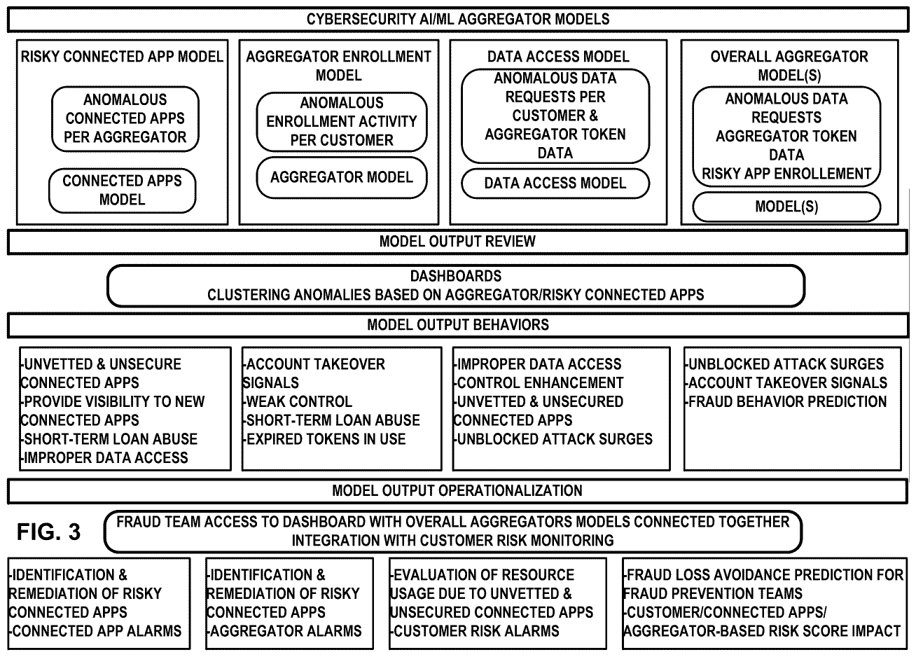

FIG. 3 is a conceptual diagram illustrating a configuration and operation of an analysis system for identifying anomalies, in accordance with one or more aspects of the present disclosure. FIG. 3 is described in the context of FIG. 2. For example, FIG. 3 may illustrate a configuration and operation of anomaly system 212.

In the example of FIG. 3, anomaly system 212 includes multiple learned models (“CYBERSECURITY AI/ML AGGREGATOR MODELS”) that may be similar to or an example of models 216. The learned models may incorporate various features and functions that include:
Learning from limited data: Models 216 may extract meaningful patterns from sparse data, making them better suited to assess risk even with limited enrollment interactions.
Adapting to new patterns: Models 216 may continuously learn and update their understanding of normal vs. suspicious behavior, allowing them to recognize novel attack patterns more quickly than rule-based systems.
Incorporating contextual information: Models 216 may process a wide range of contextual signals, including the reputation of referring apps, the timing and sequence of enrollment attempts across multiple services, and subtle indicators of automation or scripted behavior.
Detecting anomalies in real-time: By analyzing a multitude of factors simultaneously, models 216 may identify suspicious enrollments as they occur, even if the individual signals do not trigger traditional thresholds.
Leverage internal fraud data: Models 216 may enable institution 103 to design and control the approach to the use of fraud data for supervised learning. Models 216 may learn from internal fraud data. Models 216 may use fraud information, which includes historical fraud cases, known attack patterns, and confirmed fraudulent enrollments, to greatly enhance the model's accuracy and effectiveness. By training on this rich dataset, models 216 may:
Identify subtle indicators of fraud that may not be apparent in external data sources.
Recognize institution-specific fraud trends and tactics.
Adjust risk assessments based on the latest fraud attempts and successful interventions.
Provide more accurate risk scores by correlating enrollment behaviors with known fraud outcomes.

Anomaly system 212 includes a connected apps model trained to identify anomalous connected applications (“RISKY CONNECTED APP MODEL”). The connected apps model may identify anomalies in connection applications associated with financial data aggregators (e.g., aggregator 106 as illustrated in FIG. 1), such as applications that are known to misuse customer data, unusual numbers of connected applications per aggregator (e.g., identifying a number of connected applications far above a median or average number per customer) and/or other anomalies associated with connected applications (“ANOMALOUS CONNECTED APPS PER AGGREGATOR”). The connected apps model may analyze the interaction data to identify anomalies as part of determining whether a connected app has an unusual number of enrollment, whether a connected app has an unusual number of enrollment errors, whether a connected app has a higher-than-normal fraud rate associated with the app, and/or whether the app makes unusual data requests.

Anomaly system 212 includes an aggregator enrollment module (“AGGREGATOR ENROLLMENT MODEL”) trained to identify anomalies in enrollment of connected applications to an aggregator and/or institution 103. The aggregator enrollment model may identify anomalies that include use of expired tokens, anomalous requests to enroll connected applications, and/or other anomalies (e.g., “ANOMALOUS ENROLLMENT ACTIVITY PER CUSTOMER”). The aggregator enrollment model may analyze the interaction data to identify anomalies as part of determining whether an account makes an unusual number of enrollment requests, whether an account has an unusual number of errors in requests, whether an account has an unusual biometric, and/or whether an account has enrolled into an app that is considered risky by institution 103.

Anomaly system 212 includes a data access model (“DATA ACCESS MODEL”) that identifies anomalies in requests for customer data and how tokens are used (e.g., “ANOMALOUS DATA REQUESTS PER CUSTOMER & AGGREGATOR TOKEN DATA”). The data access model may analyze the interaction data to identify anomalies as part of determining whether an account has unusual data requests in both size and amount (e.g., unusual scope in data requested, how often the data is requested), whether the account is associated with improper data requests that cause errors, and/or whether the account is associated with requests that use proper authentication.

Anomaly system 212 includes a risk aggregator that aggregates outputs and features from the models of anomaly system 212 (“OVERALL AGGREGATOR MODEL(S)”). Anomaly system 212 may include a separate risk aggregator component or include the risk aggregator as functionality provided by analysis module 260. In some examples, the risk aggregator may be a learned model that uses the outputs of other models to identify anomalies. The risk aggregator may aggregate anomalies identified by the learned models into a risk profile associated with a customer identifier. For example, the risk aggregator may aggregate the identified anomalies (e.g., “ANOMALOUS DATA REQUESTS, AGGREGATOR TOKEN DATA, RISK APP ENROLLMENT, etc.) into a risk profile that reflects or is indicative of the risk to customer information posed by a use of the financial information aggregator and/or connected applications.

Anomaly system 212 may provide the output of the learned models and/or risk aggregator for review (“MODEL OUTPUT REVIEW”). Anomaly system 212 may generate a user interface that includes visual elements corresponding to the outputs of the learned models and/or risk aggregator for review by one or more individuals or entities (e.g., a fraud management specialist). For example, anomaly system 212 may generate a user interface that includes a dashboard, with the dashboard including visual elements corresponding to the outputs of the learned models. Further, anomaly system 212 may generate the dashboard as including a visual representation of cluster of anomalies (e.g., “CLUSTERING ANOMALIES BASED ON AGGREGATOR/RISKY CONNECTED APPS”) and output the user interface via one or more output components and/or to another computing system or device.

Anomaly system 212 may use the learned models and/or risk aggregator to identify various types of unwanted behavior. Anomaly system 212 may use the learned models and/or risk aggregator to identify anomalies that are representative of or indicative of the unwanted behavior. Anomaly system 212 may use the connected app model to identify one or more types of behavior associated with connections app (e.g., “UNVETTED & UNSECURE CONNECTED APPS”, “PROVIDE VISIBILITY TO CONNECTED APPS”, SHORT-TERM LOAN ABUSE” (e.g., misuse of customer data to offer predatory loans), and/or “IMPROPER DATA ACCESS”). Anomaly system 212 may use the aggregator enrollment model to identify one or more types of behavior associated with enrollment of connected applications (e.g., “ACCOUNT TAKEOVER SIGNALS”, “WEAK CONTROLS” (e.g., weak data controls by the connected applications), “SHORT-TERM LOAN ABUSE” (e.g., offering predatory loans or financial products, using customer data to offer unwanted products/service, etc.), and/or “EXPIRED TOKENS IN USE”). Anomaly system 212 may use the data access model to identify behaviors that are consistent with improper or malicious data access (e.g.,-IMPROPER DATA ACCESS”, “CONTROL ENHANCEMENT”, “UNVETTED & UNSECURED CONNECTED APPS”, “UNBLOCKED ATTACK SURGES”, etc.). Anomaly system 212 may use the risk aggregator to identify behaviors that are consistent with overall unwanted actions (e.g., “-UNBLOCKED ATTACK SURGES”, “ACCOUNT TAKEOVER SIGNALS”, “FRAUD BEHAVIOR PREDICTION”, credential stuffing, money laundering, etc.).

Anomaly system 212 may execute or perform one or more actions based on the identified behaviors (“MODEL OUTPUT OPERATIONALIZATION”). Anomaly system 212 may provide access to the outputs of the learned models and/or identified behaviors to one or more recipients (e.g., “FRAUD TEAM ACCESS TO DASHBOARD WITH OVERALL AGGREGATORS MODELS CONNECTED TOGETHER INTEGRATION WITH CUSTOMER RISK MONITORING”). For example, anomaly system 212 may generate a user interface that includes visual elements corresponding to indications of identifier anomalies and/or behaviors for one or more customers and output the user interface to a fraud team of institution 103.

Anomaly system 212 may generate the user interface as including one or more visual elements corresponding to information regarding the anomalies and/or identified behaviors. Anomaly system 212 may generate visual elements that correspond to the anomalies identified behaviors for one or more of the learned models and/or risk aggregator. For the connected app model, anomaly system 212 may include information that includes “IDENTIFICATION & REMEDIATION OF RISKY CONNECTED APPS” and “CONNECTED APP ALARMS”. For the aggregator enrollment model, anomaly system 212 may include information that includes “IDENTIFICATION & REMEDIATION OF RISKY CONNECTED APPS” and “AGGREGATOR ALARMS”. For the data access model, anomaly system 212 may include information that includes “EVALUATION OF RESOURCE USAGE DUE TO UNVETTED & UNSECURED CONNECTED APPS” and “CUSTOMER RISK ALARMS”. For the risk aggregator, anomaly system 212 may include information that includes “FRAUD LOSS AVOIDANCE PREDICTION FOR FRAUD PREVENTION TEAMS” and “CUSTOMER/CONNECTED APPS/AGGREGATOR-BASED RISK SCORE IMPACT”. Anomaly system 212 may output the user interface via one or more output components and/or provide data regarding the user interface to one or more recipients.

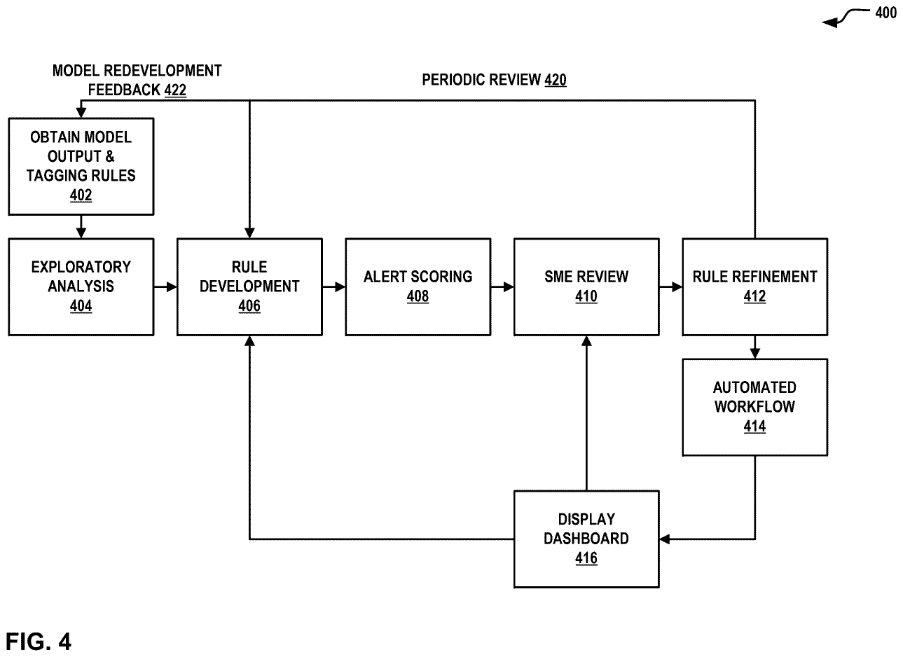

FIG. 4 is a flow diagram illustrating an example operation for training a learned model, in accordance with one or more aspects of the present disclosure. FIG. 4 is described in the context of FIG. 1. For example, anomaly system 112 may perform one or more operations illustrated in FIG. 4.

Anomaly system 112 may obtain model output and tagging rules (402). For example, anomaly system 212 obtains model output and tagging rules generated by one or more entities, such as SME 119 using SME system 118. Additiaonlly, or alternatively, anomaly system 112 obtains rules for incorporation into and/or for further training of models 116. For example, anomaly system 112 may obtain tagging rules for use in updating weights of one or more of models 116. In some examples, anomaly system 112 may generate or obtain a training set that is based on based on data indicative of fraudulent access to the data. For instance, anomaly system 112 may use previously identified anomalies to generate a training set for further development of models 116.

Anomaly system 112 may cause a model to conduct exploratory analysis (404). Anomaly system 112, for instance, applies the model to a training set of data that includes known anomalies and/or that is based on previously analyzed interaction data. Anomaly system 112 may cause the model to conduct one or more types of exploratory analysis that include frequency count, contingency tables, time series pattern, pareto analysis, and/or other types of exploratory analysis. For example, anomaly system 112 may apply the model to a corpus of training data that includes interaction data analyzed by fraud experts and compare the output of the model to a known classification of the training data. Anomaly system 112 may receive identifications of anomalies within the training data as output from the model. In some examples, anomaly system may apply one or more algorithms to the training set and select a machine learning algorithm from the one or more algorithms.

Anomaly system 112 may perform a rule development process (406). For example, anomaly system 112 develops rules that define how alerts to be classified and prioritized based on one or more factors that include severity (Anomaly score, volume of threats detected, potential impact), credibility of the alert source (feature importance, results based on historical trend/relevance), and/or SME feedback. For example, anomaly system 112 may use feedback from an SME to develop rules used to identify anomalies.

Anomaly system 112 may conduct an alert scoring process (408). For example, anomaly system 112 conducts an alert scoring process by applying models 116 to interaction data 124 and/or training data. For example, anomaly system 112 may apply models 116 to training data and analyze the output of models 116. Anomaly system 112 may perform aggregation and group alerts that may be related to the same incident to reduce the number of alerts that need to be individually investigated. Additionally, or alternatively, anomaly system 112 may perform correlation: link related alerts based on time, similarity of usage pattern, 4th party application enrollment, or attacker tactics. Anomaly system 112 may use the alert scoring processing to help to identify larger patterns or attacks of similar in nature.

Anomaly system 112 may perform SME review (410). For instance, anomaly system 112 requests SME review from SME system 118 and/or enable SME 119 to provide feedback via anomaly system 112. For example, anomaly system 112 may receive feedback from an SME regarding changes to models 116. Anomaly system 112 may request or perform SME review to enable refinement of unsupervised learned models and evaluation of model predictions. An SME may review the model output to redevelop/improve the model until errors are corrected and model performance reaches a satisfactory threshold. SMEs may review the model using one or more statistics that include recall (percent of suspicious events correctly detected by the model based on SME review) and/or false positive rate (percent of normal events that are incorrectly detected as suspicious by the model) among other statistics. In addition, anomaly system 112 may perform SME review that includes tuning a machine learning parameter based on feedback that includes tagging rules from a subject matter expert.

Anomaly system 112 may conduct rules refinement (412). For example, anomaly system 112 refines the rules by updating one or more of the rules and/or generating new rules. In an example, anomaly system 112 receives feedback from SME 119. Anomaly system 112 system generates refined rules for models 116.

Anomaly system 112 may conduct an automated workflow (414). For instance, anomaly system 112 conducts an automated workflow that includes one or more actions for updating a model and/or generating a user interface to facilitate additional feedback on the model. Anomaly system 112 may generate a dashboard that displays alert-data, prioritization levels, and investigation status. Anomaly system 112 may automatically generate reports for high-priority alerts with relevant data and initial analysis findings to speed up investigation process.

Anomaly system 112 may generate and output a dashboard for display (416). Anomaly system 112 generates a dashboard that includes one or more visual elements that correspond to different information, such as reports, alerts, analysis findings, model performance, and/or other information for instance. Anomaly system 112 may generate a dashboard and provide the dashboard to one or more recipients, such as SME system 118.

Anomaly system 112 may perform periodic review (420) based on the rule refinement process. For example, anomaly system 112 conducts periodic review of model performance according to a monthly, quarterly, annually, weekly, and/or daily basis. Anomaly system 112 may conduct one or more types of review that include reviewing model performance, determining new attack vectors, changing priorities for types of anomalies, and/or other types of review that may implicate the usage and performance of anomaly system 112. Anomaly system 112 may coordinate with other systems, such as SME system 118, in conducting the review. In an example, anomaly system 112 provides an indication to review to SME system 118. SME system 118 generates feedback on changing priorities for types of anomalies to identify and provides the feedback to anomaly system 112.

Anomaly system 112 may receive model development feedback (422). Anomaly system 112 receive model development feedback that includes updates to rules, changes to models 116, and/or other information for example. In some examples, anomaly system 112 may receive model development feedback that includes output from one or more models and tagging rules.

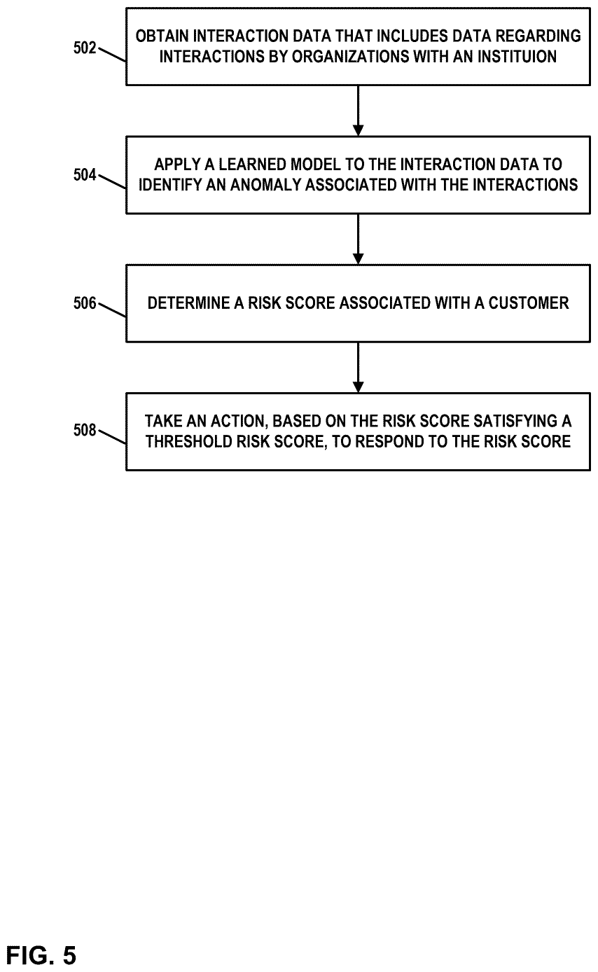

FIG. 5 is a flow diagram illustrating an example operation performed by an anomaly system, in accordance with one or more aspects of the present disclosure. FIG. 5 is described in the context of FIG. 1.

A computing system, such as anomaly system 112, obtains interaction data, such as interaction data 124, that includes data regarding interactions by organizations with an institution (502). Anomaly system 112 may obtain interaction data 124 based on interactions that include requests for data maintained by institution 103 (e.g., customer data store 104) for each of a plurality of customers of institution 103 and that occur through aggregator 106. For example, an organization, such as organization 109A associated with fourth-party app 108A, may provide a request for customer information to aggregator 106 which in turn requests the customer information from data access system 102 via API 126.

Anomaly system 112 applies a learned model, such as models 116, to interaction data 124 to identify an anomaly associated with the interactions (504). Anomaly system 112 may identify an anomaly that is associated with a specific customer, such as customer 130 of the plurality of customers of institution 103. Anomaly system 112 may apply one or more of models 116 to identify the anomaly, where each of models 116 is trained to identify different types of anomalies. Anomaly system 112 may apply models 116 to identify types of anomalies that include anomalous token use, anomalous enrollments of apps, anomalous requests for data, anomalous use of tokens, and/or other anomalies. In an example, anomaly system 112 obtains interaction data 124 using collector 114. Anomaly system 112 applies models 116 to identify different types of anomalies within interaction data 124. Models 116 output an identification of at least one anomaly. In some examples, anomaly system 112 may aggregate the output of models 116 into an aggregated risk profile associated with the customer.

Anomaly system 112 determines a risk score associated with the customer (506). Anomaly system 112 may determine the risk score based on the identification of the anomaly by applying models 116. Anomaly system 112 may determine a risk score that is a numerical score, a vector, and/or other type of score. In an example, anomaly system 112 applies models 116 to interaction data 124 to identify anomalies within interaction data. Anomaly system 112 determines a risk score that is indicative of the risk of misuse of customer information based on the identified anomalies.

Anomaly system 112 takes an action, based on the risk score satisfying a threshold risk score, to respond to the risk score (508). Anomaly system 112 may determine whether the risk satisfies one or more risk score thresholds that may be predetermined by institution 103. Anomaly system may take one or more actions that include generating an alarm, generating instructions configured to cause remediation system 122 to perform actions (e.g., blocking access to customer data store 104 for a connected application, blocking access to customer data store 104 for an aggregator, etc.), referring a customer's account for manual review by a member of institution 103, disabling login of an account pausing the issuance of tokens, and/or other actions.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The disclosures of all publications, patents, and patent applications referred to herein are each hereby incorporated by reference in their entireties. To the extent that any such disclosure material that is incorporated by reference conflicts with the instant disclosure, the instant disclosure shall control.

For ease of illustration, only a limited number of devices (e.g., anomaly system 112 as well as others) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated in the Figures herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed:

1. A method, comprising:
obtaining, by a computing system of an institution, interaction data that includes data regarding interactions by organizations with the institution, wherein the interactions include requests for data maintained by the institution for each of a plurality of customers of the institution, and wherein the interactions by the organizations occur through an aggregator organization;
applying, by the computing system, a learned model to the interaction data to identify an anomaly associated with the interactions, wherein the anomaly is associated with a specific customer of the plurality of customers of the institution;
determining, by the computing system and based on the identification of the anomaly, a risk score associated with the customer; and
taking an action, by the computing system and based on the risk score satisfying a threshold risk score, to respond to the risk score.

2. The method of claim 1, wherein taking action includes:
sending a control signal to an external system to change an operation of the external system, where changing the operation of the external system includes at least one of: generating an alarm, changing access permissions, modifying network operations.

3. The method of claim 1, wherein the aggregator organization is a financial data aggregator that accesses the data maintained by the institution for each of the plurality of customers from the institution pursuant to open banking regulations that facilitate access to the data, and wherein the organizations are financial services organizations.

4. The method of claim 1, wherein the learned model is a plurality of learned models, including a model learned to identify organizations as exceeding an application risk threshold.

5. The method of claim 1, wherein the learned model is a plurality of learned models, including a model learned to identify an anomalous enrollment of an organization.

6. The method of claim 1, wherein the learned model is a plurality of learned models, including a model learned to identify anomalous access of the data by one of the organizations.

7. The method of claim 1, wherein the learned model is a plurality of learned models, and wherein the method further comprises:
aggregating, by the computing system, outputs of the plurality of learned models into an aggregated risk profile.

8. The method of claim 1, further comprising:
determining, by the computing system and based on the anomaly, a root cause of the anomaly.

9. The method of claim 1, wherein the applying the learned model further comprises:
generating, using the learned model, a context associated with the specific customer.

10. The method of claim 1, further comprising:
training, by the computing system, the learned model, wherein training the learned model comprises:
generating a training set based on data indicative of fraudulent access to the data;
applying one or more algorithms to the training set;
selecting a machine learning algorithm from the one or more algorithms; and
tuning a machine learning parameter based on feedback that includes tagging rules from a subject matter expert.

11. The method of claim 1, wherein applying the learned model to identify the anomaly further comprises:
comparing the interactions to interactions within a historical window;
analyzing interactions for a predetermined periodic based on types of interactions; and
comparing, over a period of time, interactions associated with the specific customer with interactions associated with other customers of the plurality of customers.

12. A computing system, comprising:
memory; and
processing circuitry in communication with the memory and configured to:
obtain interaction data that includes data regarding interactions by organizations with an institution, wherein the interactions include requests for data maintain by the institution for each of a plurality of customers of the institution, and wherein the interactions by the organizations occur through an aggregator organization;
apply a learned module to the interaction date to identify an anomaly associated with the interactions, wherein the anomaly is associated with a specific customer of the plurality of customers of the institution;
determine, based on the identification of the anomaly, a risk score associated with the specific customer; and
take an action, based on the risk score satisfying a threshold risk score, to respond to the risk score.

13. The computing system of claim 12, wherein to take an action, the processing circuitry is further configured to:
send a control signal to an external system to change an operation of the external system, where changing the operation of the external system includes at least one of: generating an alarm, changing access permissions, modifying network operations.

14. The computing system of claim 12, wherein the aggregator organization is a financial data aggregator that accesses the data maintained by the institution for each of the plurality of customers from the institution pursuant to open banking regulations that facilitate access to the data, and wherein the organizations are financial services organizations.

15. The computing system of claim 12, wherein the learned model is a plurality of learned models, including a model learned to identify organizations as exceeding an application risk threshold.

16. The computing system of claim 12, wherein the learned model is a plurality of learned models, including a model learned to identify an anomalous enrollment of an organization.

17. The computing system of claim 12, wherein the learned model is a plurality of learned models, including a model learned to identify anomalous access of the data by one of the organizations.

18. The computing system of claim 12, wherein the learned model is a plurality of learned models, and wherein the processing circuitry is further configured to:
aggregate outputs of the plurality of learned models into an aggregated risk profile.

19. The computing system of claim 12, wherein the processing circuitry is further configured to:
determine, based on the anomaly, a root cause of the anomaly.

20. Non-transitory computer-readable media, configured with instructions that, when executed, cause processing circuitry to:
obtain interaction data that includes data regarding interactions by organizations with an institution, wherein the interactions include requests for data maintain by the institution for each of a plurality of customers of the institution, and wherein the interactions by the organizations occur through an aggregator organization;
apply a learned module to the interaction date to identify an anomaly associated with the interactions, wherein the anomaly is associated with a specific customer of the plurality of customers of the institution;
determine, based on the identification of the anomaly, a risk score associated with the specific customer; and
take an action, based on the risk score satisfying a threshold risk score, to respond to the risk score.
